(19) United States
(12) Patent Application Publication
(10) Pub. No.: US 2008/0177560 A1
(43) Pub. Date: Jul. 24, 2008

(54) ID Lending system, computer-readable recording medium storing ID lending program, and ID lending method

(75) Inventor: Tadafusa NIINOMI, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/008,165

(22) Filed: Jan. 9, 2008

(30) Foreign Application Priority Data
Jan. 22, 2007 (JP) 2007-12031

(51) Int. Cl. G06Q 10/00

(52) U.S. Cl. 705/1

(57) ABSTRACT

An ID lending system uses an ID management table having a correlation between an ID and a request source which specifies a source of a lending request of the ID. An ID lending unit searches the ID management table for a request source upon receiving a lending request of an ID from the request source, replying with an ID to the request source wherein the ID corresponds to the request source. An ID lending continuation verification unit receives a lending continuation request of the ID from the request source to which the ID lending unit replied with the ID. When a predetermined time period has not elapsed since the lending continuation request was received, the ID lending unit does not reply even when the lending request is received from the request source to which the ID lending unit replied.

### BACKGROUND OF THE INVENTION

1. Field of the Invention

The present invention relates to a license issuing process for a license that authenticates execution of an application program in accordance with a license key, and more particularly, to a field for adapting a redundancy scheme, such as a virtualization scheme, to a licensing server.

2. Description of the Related Art

Conventionally, license-server use licensing management methods have been used to restrict, for example, the number of simultaneous usages and the expiration time for usage of application programs. According to such a license-server use licensing management method, an application program requests the licensing server to issue a license; however, when unable to obtain the license, the application program terminates execution.

The licensing server limits, for example, the number of simultaneous usages and the expiration date for the usage of the application program in accordance with a license key issued by a software vender who supplies the application program. An illegal usage of a license key would result in illegal usage of a corresponding application program, so the license key is created to be usable only in a licensing server having a preliminarily requested and registered hardware specific ID (“hardware ID”).

For the hardware ID, a number guaranteed by a manufacturer to be a unique value similar to a MAC address, hostid, WWN (World Wide Name) or the like is used.

In recent years, server-system virtualization schemes have been popularly used to meet demand for improving reliability. A server-system virtualization scheme is configured such that a storage device storing, for example, an OS (operating system) and application programs, is located separately from a server system on a network, and the server system is used to boot a different server system. Thereby, in the event of failure in one server system, an identical operation state of a pre-failure operation state is created.

Even when the virtualization scheme is used, however, the hardware ID cannot be succeeded to the different server system. As such, although the conventional virtualization scheme is designed to improve reliability of the licensing server, the hardware ID is changed in the event of switching between server systems. The different hardware ID renders the license key unusable, consequently disabling adaptation of the virtualization scheme.

A conventional licensing management system will be described herein. FIG. 9 is a diagram showing a schematic of the conventional licensing management system. The conventional licensing management system shown therein includes a licensing server 10 and information processor 20 located in a user environment, and a license issuer 30 located in a software vendor environment.

The licensing server 10 includes a licensing management function 11 that limits, for example, the number of simultaneous usages and expiration time for usage of an application program in accordance with a license key contained in a license file 12 provided from a software vendor. In order to prevent illegal usage of the license key, the licensing management function 11 prohibits software operation in the event that a hardware ID 13 does not match with an ID contained in the license key. The hardware ID 13 is an ID specific to the licensing server 10.

The information processor 20 is an apparatus that operates an application program targeted for licensing management. In the event of transition into an executable state as an application process 21, the application program targeted for licensing management issues a request to the licensing management function 11 for issuing a license. In the event the application program is unable to obtain the license, it terminates its own execution.

The license issuer 30 is an apparatus that generates the license file 12 containing the license key. The license key contains, for example, the hardware ID 13 of the licensing server 10 that permits the use of the license file 12 and information related to, for example, the number of simultaneous usages and expiration time for usage of the application program.

A processing procedure for operating the conventional licensing management system will be described herein. In sequential operations for operating the licensing server 10, first, a registration request 14 containing a written hardware ID of the licensing server 10 is created by a user. Additionally written in the registration request 14 are, for example, usage conditions, such as the number of simultaneous usages and expiration time for usage of the application program (step S11).

The registration request 14 is then forwarded to a software vendor (step S12). In response, the software vendor inputs written contents of the registration request 14 into the license issuer 30 (step S13). As a consequence, a license file 12 containing a license key has, for example, an encrypted hardware ID 13 and usage conditions (step S14).

The license file 12 is forwarded to the user, and the user operates to store the forwarded license file 12 into the licensing server 10 (step S15). According to the procedure described above, the licensing management function 11 of the licensing server 10 is able to effectively perform its function.

After the preparatory operation has thus been completed, the licensing management function 11 of the licensing server 10 reads the license key contained in the license file 12, and decrypts the encrypted license key (step S16). Thereby, the hardware ID 13 is obtained. In the event that the hardware ID 13 matches the ID contained in the license key, then the procedure initiates acceptance of license issuance (step S17).

In the event that the hardware ID 13 does not match with the ID contained in the license key, the licensing management function 11 terminates the function without initiating or starting the acceptance of license issuance.

Then, in the event of transition into an executable state as an application process 21, the application program, which is targeted for licensing management and stored in the information processor 20, issues a request to the licensing management function 11 for license issuance (step S18).

Having accepted the request, the licensing management function 11 determines whether or not the application program is executable, in accordance with the usage conditions contained in the license key. If the application program is determined to be executable, then license issuance is executed. Otherwise, if the application program is determined to be unexecutable, the license issuance is denied (step S19). When the license issuance has been able to be executed, the application process 21 continues the operation, or otherwise stops its own execution.

With reference to FIG. 10, an example of a configuration using a virtual server 1 in place of the licensing server 10 in a conventional licensing management system will be described hereinbelow. In the present example shown in FIG. 10, licensing servers 10a and 10b have configurations similar to each other.

A storage device 40 storing an OS of the licensing server 10a and the like exists in a fiber channel network 2, and is set to permit only accesses from the licensing server 10a in accordance with the WWN. The licensing server 10a accomplishes the licensing management function 11 by executing a predetermined program stored in the storage device 40.

An address conversion gateway 50 (shown as “GW”) is provided between the licensing servers and the storage device 40. In the case where the process in the licensing server 10a has to be taken over by the licensing server 10b for some reason, the address conversion gateway 50 performs address conversion so that a WWN of the licensing server 10b is recognized to be a WWN of the licensing server 10a by the storage device 40.

The address conversion enables the licensing server 10b to boot by using, for example, an OS thereof stored in the storage device 40. After completion of the boot operation, a software environment identical to a software environment realized in the licensing server 10a is realized in the licensing server 10b. More specifically, the licensing server 10b uses an IP address identical to that of the licensing server 10a to perform communication, thereby to realize the licensing management function 11.

For this reason, it is recognizable to the information processor 20 in which the licensing servers 10a and 10b are connected together across a LAN (local area network) 3 as if the virtual server 1 is continually operating before and after server switching. Thus, the server virtualization scheme enables a post-switched server to provide a client with services identical to those of a pre-switched server.

On the other hand, however, using the server virtualization scheme disables the conventional licensing management system to appropriately operate. A case is now contemplated in which switching from the licensing server 10a to the licensing server 10b has occurred in the example shown in FIG. 10. In this case, the licensing server 10b boots by using the OS stored in the storage device 40.

The licensing management function 11 of the license server 10b reads a license key from the license file 12 stored in the storage device 40, and then performs a comparison between an ID 13a contained in the read-out license key and a hardware ID 13b specific to the licensing server 10b. In this case, however, the ID 13a contained in the license key is a hardware ID specific to the licensing server 10a for the use of functioning the licensing management function 11 of the licensing server 10a.

For this reason, the hardware ID 13a contained in the license key never matches with the hardware ID 13b, so that the licensing management function 11 of the licensing server 10b stops its function. Thus, in the conventional licensing management system described above, the licensing management function is configured to function only in the licensing server having the specific hardware ID. Consequently, although the software environment cannot be succeeded by using the server virtualization scheme, succession of the licensing management function can be realized.

### SUMMARY

According to an aspect of an embodiment, an ID lending system for lending an ID includes an ID management table having a correlation between an ID and a request source which specifies a source of a lending request of the ID. An ID lending unit searches the ID management table for a request source upon receiving a lending request for an ID from the request source, and replies to the request source. An ID lending continuation verification unit receives a lending continuation request for the ID from the request source to which the ID lending unit responded. When a predetermined time period has not elapsed since the lending continuation request was received, the ID lending unit does not respond to the ID even when the lending request is received from the request source to which the ID lending unit responded earlier.

### BRIEF DESCRIPTION OF THE DRAWINGS

FIG. 1 is a diagram showing an outline of a licensing management system of an embodiment of the present invention;

FIG. 2 is a block diagram showing the configuration of the licensing management system of the embodiment;

FIG. 3 is a diagram showing an example of a license usage status table;

FIG. 4 is a diagram showing an example of an ID management table;

FIG. 5 is a flowchart representing a processing procedure to be executed by a licensing server;

FIG. 6 is a flowchart representing a processing procedure to be executed by an ID lending system;

FIG. 7 is a diagram showing an example of an ID management table in the event of identification of licensing servers by using MAC addresses;

FIG. 8 is a functional block diagram showing a computer for executing an ID lending program;

FIG. 9 is a diagram showing an outline of a conventional licensing management system; and

FIG. 10 is an explanatory diagram of a configuration using a virtual server as a licensing management system.

### DETAILED DESCRIPTION OF THE EMBODIMENTS

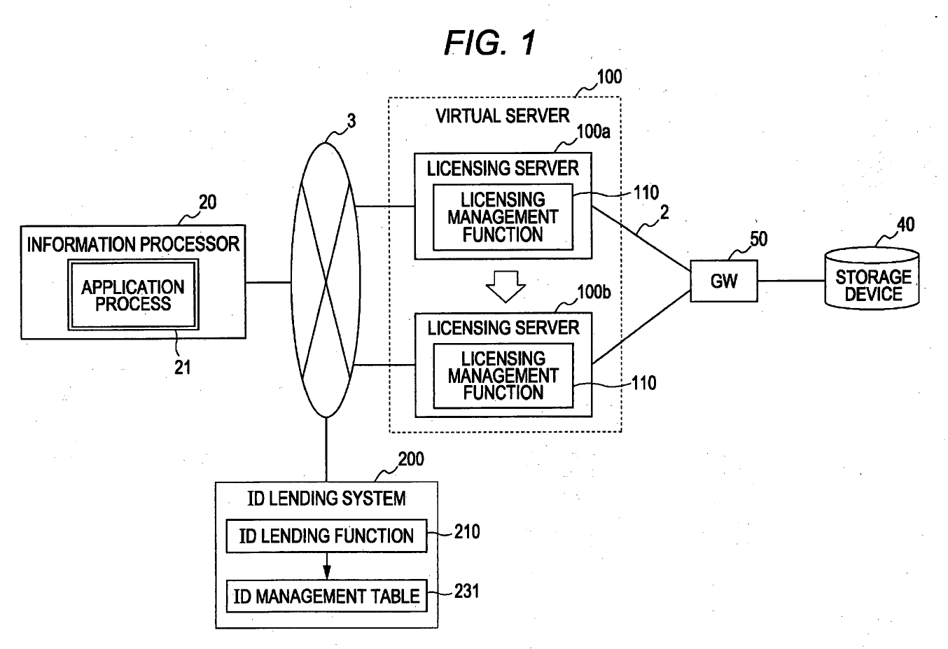

A licensing management system according to an embodiment of the present invention will be described herebelow. FIG. 1 is a view showing a schematic of the licensing management system of the embodiment. In the embodiment shown in FIG. 1, licensing servers 100a and 100b have configurations similar to each other.

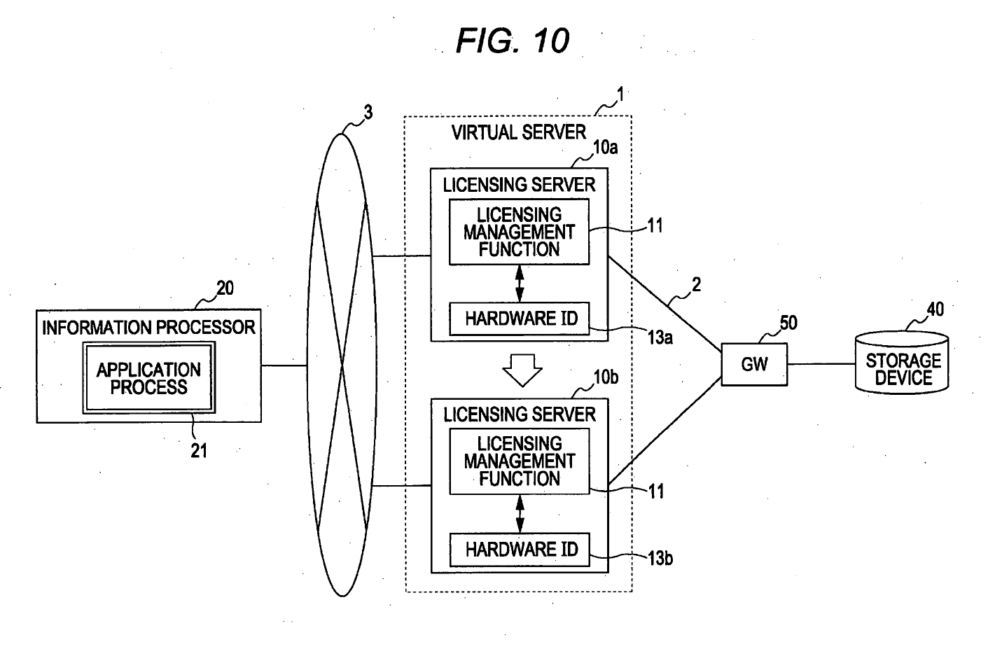

The licensing servers 10a and 100b together constitute a virtual server 100. The virtual server 100 is constituted such that, similar to the example shown in FIG. 10, a storage device 40, which stores OSs and the like of the respective licensing servers 100a and 100b, exists in a fiber channel network 2, and an address conversion gateway 50 is provided between the respective licensing servers 100a and 100b and the storage device 40.

The licensing servers 10a and 100b are connected to an ID lending system 200 across a LAN 3. An ID lending function 210 of the ID lending system 200 lends to a preliminarily registered licensing server an ID associated with the licensing server. The ID lending function 210 further provides management to prevent an identical ID from synchronously being lent to another licensing server.

A licensing management function 110 of the respective licensing servers 100a, 100b executes a comparison between a requested ID and an ID contained in a license key received from the ID lending system 200, thereby to prevent illegal ID use. This is different from the conventional manner that executes a comparison between the ID specific to the corresponding server 110a, 110b and the ID contained in the license key, thereby to prevent illegal usage.

Thus, according to the licensing management system of the present embodiment, even in the event of virtualization of the licensing server, the licensing management function 110 of the switched licensing server can be normally operated.

In the configuration of FIG. 1, during the operation of the licensing server 100a, the licensing server 100b need not be held in a standby mode only as a substitute device dedicated to the licensing server 100a, but can also be used as a substitute device for any other device having a configuration similar to the licensing server 100b.

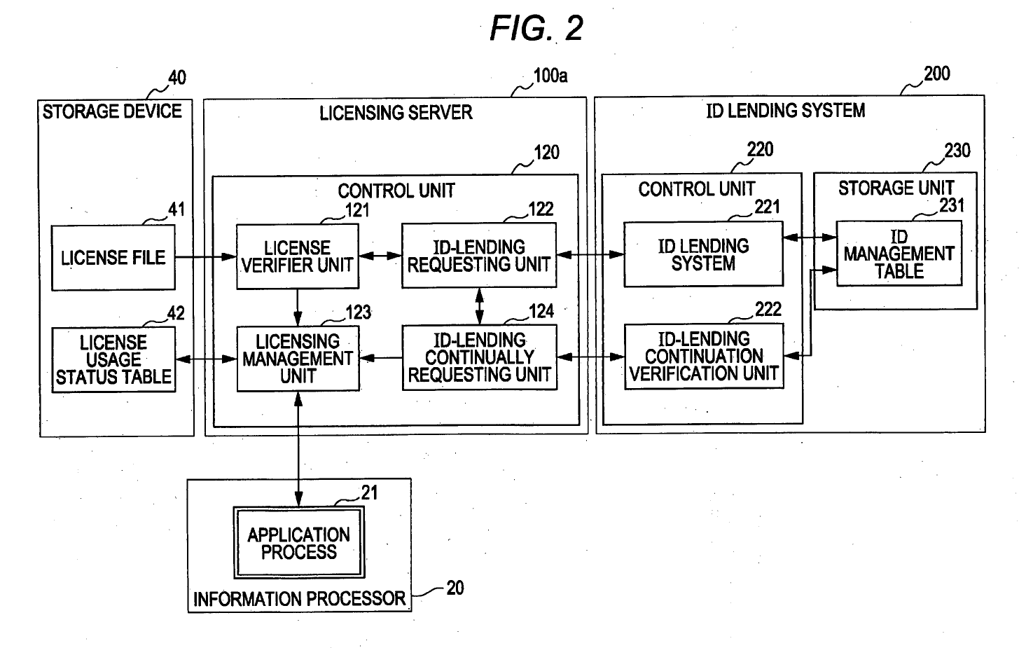

The configuration of the licensing management system shown in FIG. 1 will be described in more detail hereinbelow. FIG. 2 is a block diagram showing the configuration of the licensing management system of the present embodiment. The licensing servers 100a and 100b have the configuration similar to each other, so that only the configuration of the licensing server 100a is shown in FIG. 2 for the sake of brevity. Further, since the configurations of an information processor 20 and the address conversion gateway 50 are well known per se, details of configurations thereof are not shown.

With reference to FIG. 2, the licensing server 100a includes a control unit 120 that realizes the licensing management function 110. The control unit 120 includes a license verifier unit 121, an ID-lending requesting unit 122, a license management unit 123, and an ID-lending continually requesting unit 124.

The license verifier unit 121 is a processing unit that reads out a license key from a license file 41 stored in the storage unit 40, and verifies whether or not an ID received through decryption of the license key is a valid one issued for the licensing server. In order to verify the ID thus received, the license verifier unit 121 requests the ID-lending requesting unit 122 to request the ID lending system 200 to lend the ID.

Instead of a hardware ID, such as a MAC address, specific to the licensing server 100a, the license file 41 is received by registry requesting a software vendor in accordance with usage conditions for the ID that is to be lent from the ID lending system 200 to the licensing server 100a. The license file 41 includes the license key including the encrypted ID and usage conditions.

The ID-lending requesting unit 122 is a processing unit that requests the ID lending system 200 for lending of the ID. In the event that the ID is provided from the ID lending system 200, the ID-lending requesting unit 122 transfers the ID to the license verifier unit 121. Otherwise, in the event that an ID-lending denial for the ID is transmitted to the requesting source, the notification is transferred to the license verifier unit 121.

Upon receipt of the ID transferred from the ID-lending requesting unit 122, the license verifier unit 121 executes a comparison between the transferred ID and the ID extracted from the license key. When a match is found between the two Ids, which means that the ID extracted from the license key is a proper ID issued for the licensing server, the usage conditions extracted from the license key are transferred to the license managing unit 123, thereby to instruct the license managing unit 123 to initiate a license issuing process.

In the event that a match is not found between the IDs transferred from the ID-lending requesting unit 122 and extracted from the license key, which means that the ID extracted from the license key is not a proper ID issued for the licensing server, the license verifier unit 121 stops the function of the control unit 120.

In the event that the ID-lending denial for the ID is received in response, which means that the ID is already lent to another licensing server, a re-request to the ID lending system 200 for ID-lending is issued to the ID-lending requesting unit 122. The re-request is thus issued in preparation for the succession of processing of the licensing server.

The license managing unit 123 is a processing unit that addresses, for example, a license issuance request transmitted from an application targeted for licensing management. The license managing unit 123 stores license usage conditions and usage status into a license usage status table 42 of the storage unit 40, and determines readiness of license issuance in accordance with the license usage status table 42.

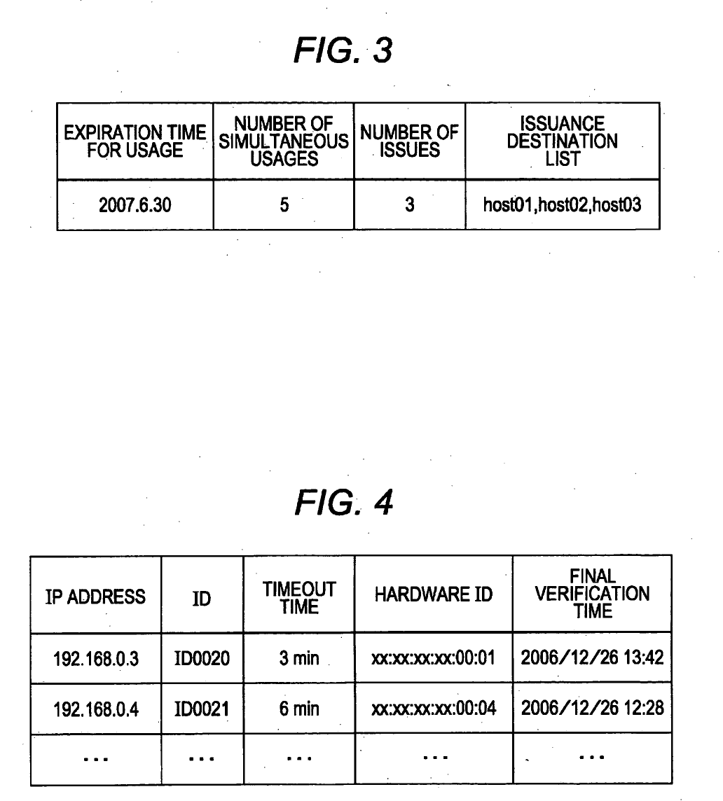

FIG. 3 is a diagram showing an example of the license usage status table 42. With reference to FIG. 3, the license usage status table 42 has entries, such as expiration date, number of simultaneous usages, number of issues, and issuance destination list. The entries of the expiration time for usage and the number of simultaneous usages are entries for setting the expiration time for usage and number of simultaneous usages extracted by the license verifier unit 121 from the license key. The number of issues is the number of licenses currently being issued, and the issuance destination list is a breakdown of the issuance destinations.

Upon acceptance of the license issuance request from the application program targeted for licensing management, the license managing unit 123 references or looks up the license usage status table 42. Then, the unit 123 issues the license and updates the value of the number of issues and the issuance destination list on the conditions that the current time does not exceed the time set for the expiration time for usage and concurrently that the value of the number of issues is less than the number of simultaneous usages.

The ID-lending continually requesting unit 124 is a processing unit that requests the ID lending system 200 to continue ID-lending. The ID lending system 200 is configured to not simultaneously lend an identical ID to a plurality of licensing servers. As such, a risky case can take place in which, in the event that a licensing server having received the lent ID from the ID lending system 200 is shut down by failure or the like, ID-lending from the ID lending system 200 cannot be accomplished even when another server attempts to succeed processing therefrom.

Then, during the acceptance period of ID-lending in the licensing server from the ID lending system 200, the ID-lending continually requesting unit 124 periodically transmits an ID-lending continuation request to the ID lending system 200. Suppose that the continuation request is not transmitted even after the elapse of a predetermined time period from the licensing server having the lent ID. In this case, it can be assumed that the licensing server having the lent ID is not functionable due to failure or the like, so that the ID lending system 200 permits lending of the ID to another licensing server.

Further, suppose that an ID-lending continuation denial is received as a result of transmission of the ID-lending continuation request to the ID lending system 200 from the ID-lending continually requesting unit 124. In this case, there is a possibility that ID-lending to a different licensing server has been executed. For this reason, the ID-lending continually requesting unit 124 instructs the license managing unit 123 to terminate processing; and further instructs the ID-lending requesting unit 122 to request the ID lending system 200 for ID-lending in preparation for the event of requiring the succession of processing of the another licensing server.

According to the procedural configuration, even when a licensing server is shut down in a state where the license server has an ID lent from the ID lending system 200, processing can be succeeded by another licensing server. Further, even when a same ID has been lent to a plurality of licensing servers for some reason, the state can be automatically resolved.

The configuration of the ID lending system 200 will be described herein. The ID lending system 200 has a control unit 220 including an ID lending unit 221 and an ID-lending continuation verification unit 222, and a storage unit 230 storing an ID management table 231.

The ID lending unit 221 is a processing unit that executes ID-lending to a licensing server, such as the licensing server 100a. More specifically, upon receipt of an ID-lending request from a licensing server, the ID lending unit 221 references or looks up the ID management table 231. When an IP address of a requesting source is registered and an ID corresponding to the IP address is not lent to any licensing server, the ID lending unit 221 transmits the ID in response or otherwise transmits an ID-lending denial for the ID.

FIG. 4 shows an example of the ID management table 231. With reference to FIG. 3, the ID management table 231 includes entries, such as an IP address, ID, timeout time, hardware ID, and final verification time. Of these entries, the IP address, ID and timeout time entries are preliminarily set by, for example, an administrator, and the hardware ID and final verification time entries are dynamically updated in value by the ID lending system 200.

The IP address in the management table refers to an IP address of a licensing server targeted for ID-lending, and the ID is an ID to be lent to the licensing server. The timeout time refers to a threshold value that is used to determine a timeout of an ID-lending continuation request from an ID-lending destination source (on an ID borrowing side). For example, assume the case of three minutes set to the threshold value. In this case, if an ID-lending continuation request for an ID is not received in the period of three minutes from an ID-lending destination, then the ID lending unit 221 permits lending of the ID to another licensing server.

The hardware ID in the management table refers to an ID specific to a licensing server at an ID-lending destination, and a MAC address or the like is set as the hardware ID. The hardware ID is set by the ID lending unit 221 in the event of execution of ID-lending. The operational configuration may be such that, in the event that the ID-lending request is made by the licensing server, the hardware ID may be requested to be explicitly specified to the ID lending system 200 or the ID lending system 200 may extract the hardware ID from, for example, a header of an exchanged electronic message text.

The final verification time in the management table refers to a time period of ID-lending or ID-lending continuation permitted by the ID lending system 200. The final verification time is used in combination with the timeout time to make a determination of timeout occurrence.

Upon receipt of an ID-lending request from a licensing server, the ID lending unit 221 searches the ID management table 231 by using an IP address of a requesting source as a keyword. If having not detected a corresponding row, then the ID lending unit 221 transmits an ID-lending denial response. Otherwise, if having detected a corresponding row, then the ID lending unit 221 operates such that a comparison is made between a time period obtained by subtracting the timeout time from the current time and the final verification time to thereby determine whether or not a timeout has occurred. If a timeout has not occurred, then the ID-lending denial response is transmitted to the requesting source.

If a timeout has occurred, on the other hand, the ID specific to the requesting source is set into the entry of the corresponding hardware ID, and the current time is set into the entry of the final verification time. Thereafter, a value of the ID in the retrieved row is provided in response to the requesting source.

The ID-lending continuation verification unit 222 is a processing unit that addresses the ID-lending continuation request issued from a licensing server, such as the licensing server 100a. More specifically, upon receipt of an ID-lending continuation request from a licensing server, the ID-lending continuation verification unit 222 searches the ID management table 231 by using an IP address of a requesting source as a keyword. If not having detected a corresponding row, then the ID-lending continuation verification unit 222 transmits an ID-lending continuation denial.

If having detected a corresponding row, then the ID-lending continuation verification unit 222 operates such that a comparison is made between a time period obtained by subtracting the timeout time from the current time and the final verification time to thereby determine whether or not a timeout has occurred. If a timeout has occurred, then an ID-lending continuation denying response (or, a “continuation denial response”, herebelow) is transmitted to the requesting source. If a timeout has not occurred, on the other hand, the current time is set into the entry of the final verification time, and an ID-lending continuation permitting response (or, “continuation permitting response”, herebelow) is transmitted to the requesting source.

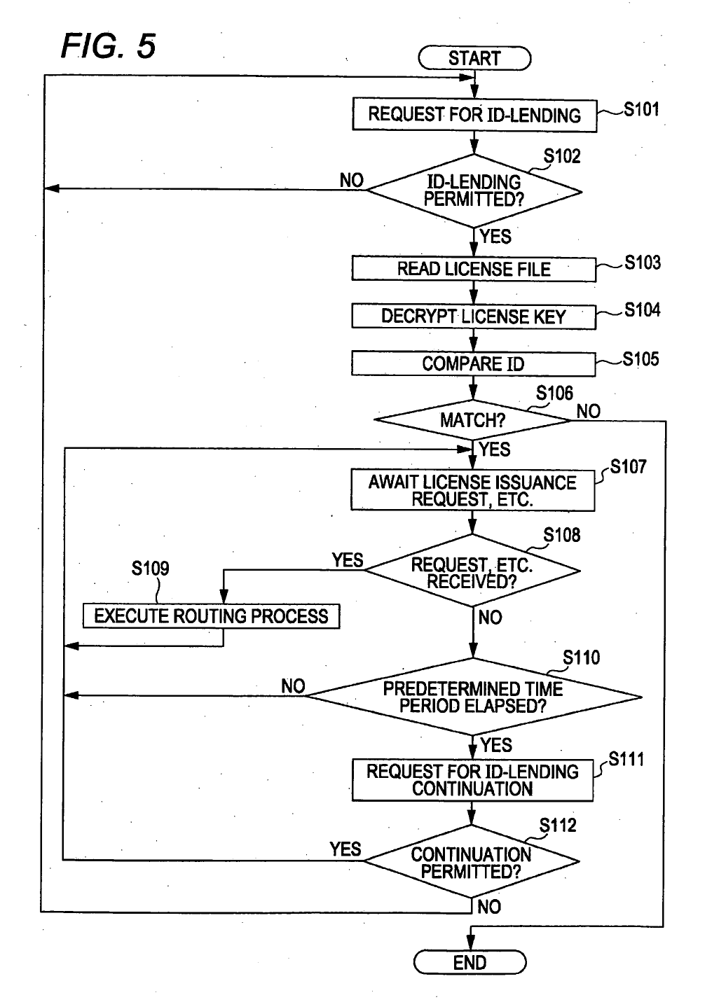

A processing procedure to be executed by the licensing server 100a and the ID lending system 200, which are shown in FIG. 2, will be described hereinbelow. FIG. 5 is a flowchart representing a processing procedure of the licensing server 100a shown in FIG. 2.

With reference to FIG. 5, upon activation of the licensing server 100a, the ID-lending requesting unit 122 operates to execute issuance of a request for ID-lending (or, “ID-lending request,” hereinbelow) of an ID to the ID lending system 200 (step S101). If an ID-lending denying response is received (step S102: “NO”), then the ID-lending requesting unit 122 returns to step S101 and again operates to execute issuance of an ID-lending request.

Alternatively, if an ID is received in response from the ID lending system 200 (step S102: “YES”), then the license verifier unit 121 reads a license file 41 (step S103), and decrypts a license key contained therein (license file 41) (step S104). Then, a comparison is made between an ID contained in the license key and the ID transmitted in response from the ID lending system 200 (step S105). If there is no match between the IDs (step S106: “NO”), then processing terminates.

If a match is found (step S106: “YES”) in the above-described comparison, then the license managing unit 123 enters a standby mode awaiting a license issuance request or the like from an application program targeted for licensing management (step S107). If having received a license issuance request or the like, (step S108: “YES”), the license managing unit 123 executes a routing process dealing with the request and the like (step S109), and then returns to step S107 to again enter the standby mode.

In a final stage, if a predetermined time period has elapsed since transmission of an ID-lending continuation request (step S110: “YES”), then the ID-lending continuation request is transmitted by the ID-lending continually requesting unit 124 to the ID lending system 200 (step S111). If a continuation permitting response is received (step S112: “YES”), then the license managing unit 123 is caused to continue the process. Otherwise, if a continuation denying response is received (step S112: “NO”), the license managing unit 123 is caused to terminate the process and to restart the processing procedure from step S101.

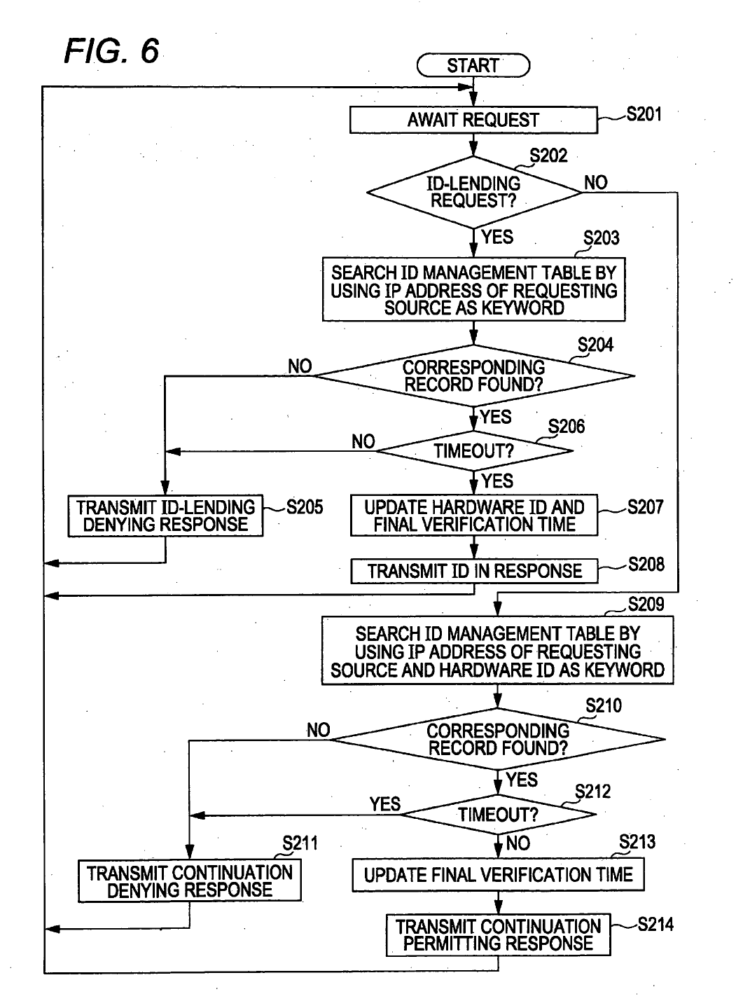

FIG. 6 is a flowchart representing a processing procedure to be executed by the ID lending system 200 shown in FIG. 2. With reference to FIG. 6, upon activation, the ID lending system 200 enters a standby mode awaiting a request from a licensing server (step S201).

Upon receipt of an ID-lending request from a licensing server (step S202: “YES”), the ID lending unit 221 searches the ID management table 231 by using an IP address of a requesting source as a keyword (step S203). If having not detected a corresponding row (step S204: “NO”), then the ID lending unit 221 transmits an ID-lending denying response (step S205), and the processing procedure is restarted from step S201.

Otherwise, if having detected a corresponding row (step S204: “YES”), then the ID lending unit 221 operates such that a comparison is made between a time period obtained by subtracting the timeout period from the current time and the final verification time to thereby determine whether or not a timeout has occurred. If a timeout has not occurred (step S206: “NO”), then the ID lending unit 221 transmits an ID-lending denying response to the requesting source, and the processing procedure is restarted from step S201.

On the other hand, if a timeout has occurred (step S206: “YES”), then the ID specific to the requesting source is set into the entry of a corresponding hardware ID in the row, and the current time is set into the entry of the final verification time (step S207). Thereafter, a value of the ID in the retrieved row is provided in response to the requesting source (step S208), and the processing procedure is restarted from step S201.

If an ID-lending continuation request is received (step S202: “NO”), then the ID-lending continuation verification unit 222 searches the ID management table 231 by using an IP address of a requesting source as a keyword (step S209). If not having detected a corresponding row (step S210: “NO”), then the ID-lending continuation verification unit 222 transmits an ID-lending continuation denial (step S211), and the processing procedure is restarted from step S201.

If having detected a corresponding row (step S210: “YES”), then the ID-lending continuation verification unit 222 operates such that a comparison is made between a time period obtained by subtracting the timeout time from the current time and the final verification time to thereby determine whether or not a timeout has occurred. If a timeout has occurred (step S212: “YES”), then a continuation denial is transmitted to the requesting source (step S211), and the processing procedure is restarted from step S201.

On the other hand, if a timeout has not occurred (step S212: “NO”), then the current time is set into the entry of the final verification time, and a continuation permitting response is transmitted to the requesting source (step S214). Thereafter, the processing procedure is restarted from step S201.

The configurations of the licensing server 100a and the ID lending system 200, which are shown in FIG. 2, can be modified in various ways without departing from the spirit and scope of the present invention. For example, in the embodiment shown and described above, control is performed by the ID management table 231 in the manner that IDs and IP addresses of licensing servers are correlated to one another. However, control may be implemented in such a manner that IDs are correlated with other types of IDs assigned to identify licensing servers and are monitored.

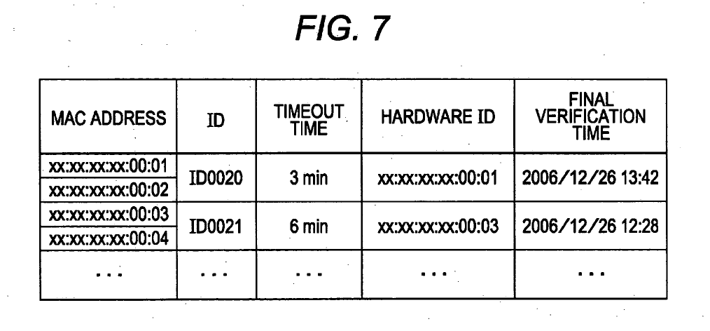

For example, with reference to FIG. 7, control may be performed in the manner that IDs and MAC addresses of licensing servers are correlated to one another. In this case, unlike the IP address, the values of MAC addresses are different from one another before and after switching between licensing servers. For this reason, a plurality of the IDs are correlated to one ID.

Further, while the ID lending system 200 is configured as the independent system in the embodiment, it may be configured by integration with other devices. For example, functions of the ID lending system 200 can be imparted to devices such as a hub and switch used for connecting together systems in the LAN.

Further, instead of the LAN 3, another communication device (means) may be used to connect between the ID lending system 200 and the licensing server such as the licensing server 100a. Such a network as an intelligent platform management bus (IPMB) dedicated for server management can be used to connect between the ID lending system 200 and the licensing server.

Further, the configuration may be such that, for example, the functions of the control unit 120 of the licensing server 100a and the control unit 220 of the ID lending system 200 are incorporated as software, and the functions are respectively executed by computers. The configuration thus formed enables the execution of functions equivalent to those of the hardware functions of, for example, the licensing server 100a and the ID lending system 200. The following describes one example of a computer that executes an ID lending program 1071 incorporating a software function as the function of the control unit 220 of the ID lending system 200. Also a licensing management program incorporating software that functions like the control unit 120 of the licensing server 100a can be executed by a computer having a similar configuration.

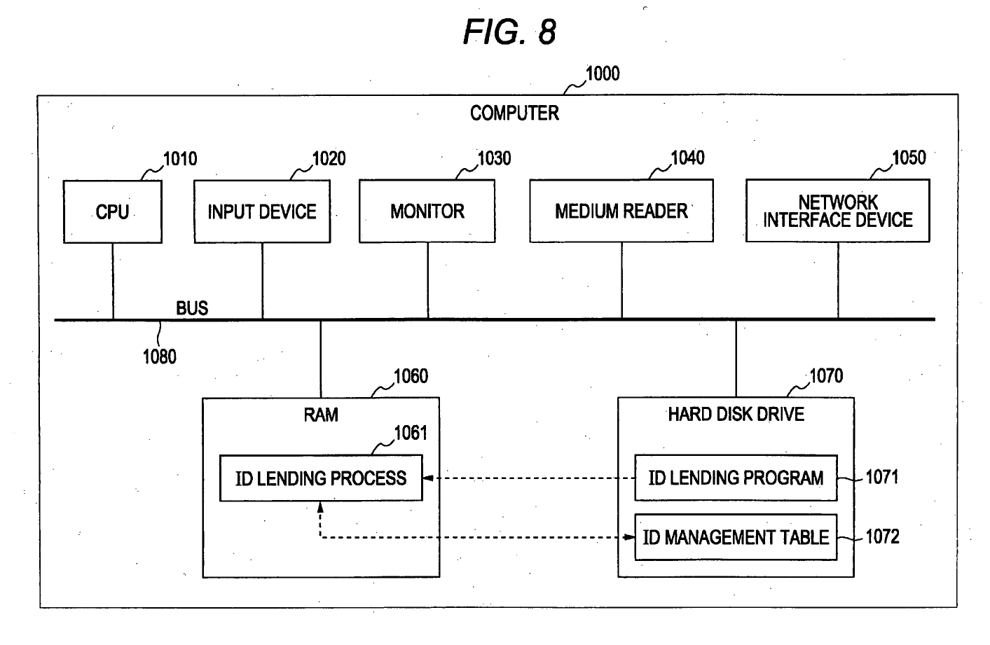

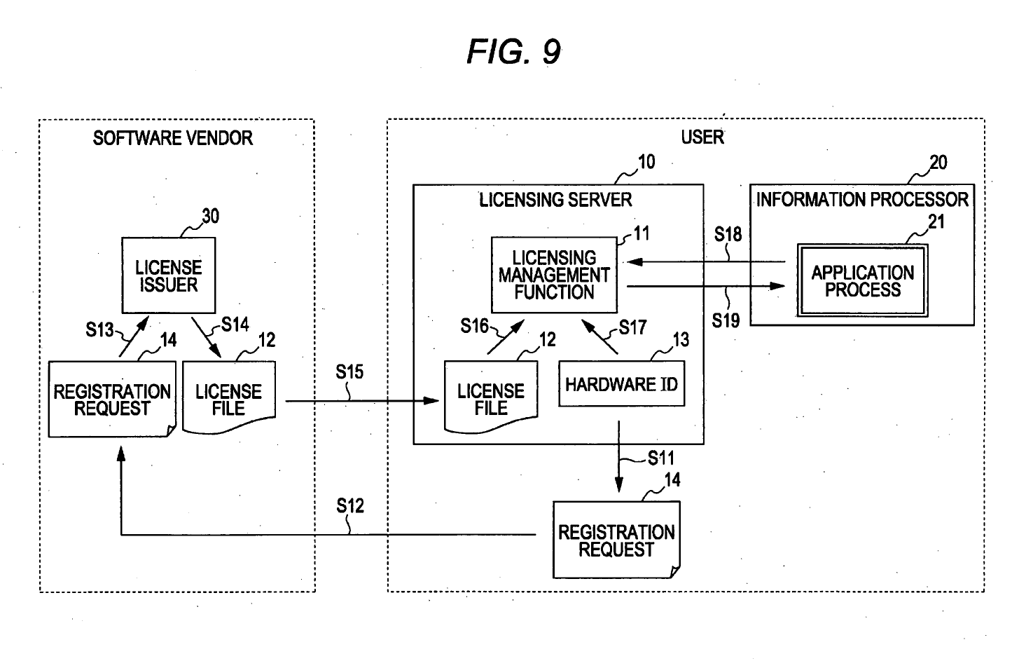

FIG. 8 is a functional block diagram showing the computer 1000 for executing the ID lending program 1071. The computer 1000 is configured to include various components connected via a bus 1080. The components are a CPU 1010 for executing various types of processing and arithmetic operations; an input device 1020 for accepting inputs of data from the user; a monitor 1030 for displaying various information; a medium reader device 1040 for reading a program and the like from a recording medium; a network interface device 1050 for performing communication of data with another computer across a network; a RAM (random access memory) 1060 for temporarily storing various information and data; and a hard disk drive 1070.

The hard disk drive 1070 stores the ID lending program 1071 having the function similar to that of the control unit 220 shown in FIG. 2 and an ID management table 1072 corresponding to the ID management table 231 shown in FIG. 2. Alternatively, the ID management table 1072 can be appropriately distributed and stored in another computer via the network.

The CPU 1010 reads the ID lending program 1071 from the hard disk drive 1070 and expands the program 1071 into the RAM 1060. Thereby, the ID lending program 1071 provides a function executable as an ID lending process 1061. The ID lending process 1061 appropriately expands information and the like read out from the ID management table 1072 into an area of the RAM 1060 allocated to itself, and executes various data processes in accordance with the expanded data and the like.

The ID lending program 1071 need not be stored in the hard disk drive 1070, but can instead be stored in a different storage medium, such as a CD-ROM (compact disk-read only memory). In this case, the ID lending program 1071 is read from the CD-ROM and is executed by the computer 1000. Still alternatively, the ID lending program 1071 may be stored in another computer (or a server) connected to the computer 1000 via, for example, a public line, Internet, LAN, or WAN (wide area network). In this case, the ID lending program 1071 is read from storage of the another computer and executed by the virtual server 100.

As described above, even when server switching has occurred, a license key can be verified by a switched server by using an identical ID after server switching.

The above-described embodiment has thus been described with reference to the example case in which the licensing servers are configured in a redundant manner by using the virtualization scheme. However, according to the present invention, the licensing servers can be configured in a redundant manner by using another scheme such as a cluster scheme.

Components of the above-described embodiment and examples or arbitrary combinations of the above-described descriptions and components of the embodiment and examples can be applied to, but not limited to, methods, apparatuses, systems, computer programs, recording mediums, and data structures. Any of such applications is valid and effective as an embodiment of the present invention.

According to the above-described embodiment of the present invention, a license key can be verified by using an ID provided by the embodiment system instead of using a hardware ID, and the redundancy scheme, such as virtualization scheme, can be applied to the licensing server(s).

Further, according to the embodiment described above, an advantage is produced in that an identical ID is prevented from being simultaneously lent to a plurality of devices (requesting sources), consequently enabling preventing the issuance of a license based on the identical license key from being executed by a plurality of licensing servers.

Further, the embodiment described above provides an advantage in that, when failure has occurred in an ID-lending destination device (on the ID borrowing side), the ID can be lent to another device that succeeded the process of the device in which the failure has occurred.

What is claimed is:

1. An ID lending system for lending an ID, the ID lending system comprising:
ID management table having a correlation between an ID and a request source which specifies a source of a lending request of the ID;
ID lending unit searching the ID management table for a request source upon receiving a lending request of ID from the request source, replying with an ID to the request source when the ID corresponds to the request source being found; and
ID lending continuation verification unit receiving a lending continuation request of ID from the request source to which the ID lending unit replied the ID,
wherein, when a predetermined time period has not elapsed since the lending continuation request was received, the ID lending unit does not reply the ID even when the lending request is received from the request source to which the ID lending unit replied the ID.

2. The ID lending system according to claim 1, wherein, when a predetermined time period has elapsed since receiving the lending continuation request, the ID lending unit replies the ID when the lending request is received from the request source to which the ID lending unit replied the ID.

3. The ID lending system according to claim 1, wherein, if the ID lending continuation verification unit receives a lending continuation request of ID from the request source to which finally the ID lending unit replied the ID within the predetermined time period, the ID lending continuation verification unit replies permission of a lending continuation, else without the predetermined time period the ID lending continuation verification unit replies denial of a lending continuation.

4. A computer-readable recording medium storing an ID lending program executed by an ID lending system, the program comprising:
ID lending step searching an ID management table for a request source upon receiving a lending request of ID from the request source, replying an ID to the request source wherein the ID corresponds to the request source being found, the ID management table having a correlation between the ID and the request source which specifies a source of lending request of the ID; and
ID lending continuation verification step receiving a lending continuation request of ID from the request source to which the ID lending step replied the ID,
wherein, when a predetermined time period has not elapsed since the lending continuation request is received, the ID lending step does not reply the ID even when the lending request is received from the request source to which the ID lending step replied the ID.

5. The computer-readable recording medium according to claim 4,
wherein, when a predetermined time period has elapsed since receiving the lending continuation request, the ID lending step replies the ID when the lending request is received from the request source to which the ID lending step replied the ID.

6. A computer-readable recording medium according to claim 4,
if the ID lending continuation verification step receives a lending continuation request of ID from the request source to which finally the ID lending step replied the ID within the predetermined time period, the ID lending continuation verification step replies permission of a lending continuation, else without the predetermined time period the ID lending continuation verification step replies denial of a lending continuation.

7. An ID lending method for lending an ID, the ID lending method comprising:
ID lending step searching an ID management table for a request source upon receiving a lending request of ID from the request source, replying an ID to the request source wherein the ID corresponds to the request source being found, the ID management table having a correlation between the ID and the request source which specifies a source of lending request of the ID; and
ID lending continuation verification step receiving a lending continuation request of ID from the request source to which the ID lending step replied the ID,
wherein, when a predetermined time period has not elapsed since the lending continuation request is received, the ID lending step does not reply the ID even when the lending request is received from the request source to which the ID lending step replied the ID.
